(19) United States
(12) Patent Application Publication
(10) Pub. No.: US 2005/0071746 A1
(43) Pub. Date: Mar. 31, 2005

(54) Networked printer with hardware and software interfaces for peripheral devices

(76) Inventors: Peter E. Hart, Menlo Park, CA (US); Jonathan J. Hull, San Carlos, CA (US); Jamey Graham, San Jose, CA (US); Kurt Piersol, Santa Cruz, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/814,751

(22) Filed: Mar. 30, 2004

Related U.S. Application Data
(60) Provisional application No. 60/506,206, filed on Sep. 25, 2003.
(60) Provisional application No. 60/506,263, filed on Sep. 25, 2003.
(60) Provisional application No. 60/506,302, filed on Sep. 25, 2003.
(60) Provisional application No. 60/506,303, filed on Sep. 25, 2003.
(60) Provisional application No. 60/506,411, filed on Sep. 25, 2003.

(51) Int. Cl. G06F 17/00

(52) U.S. Cl. 715/500.1

(57) ABSTRACT

A networked printing system enables the printing of multimedia data received by a printer from local and networked peripheral devices. The printing system applies multimedia functions to the multimedia data and produces a paper or other printed output as well as a related electronic output. Together, the printed and electronic outputs provide a representation of the multimedia. The printer is also capable of communicating and controlling the functionality of the networked devices. Depending on the desired application for the printer, the printer may include any combination of mechanisms for receiving media data, printing the printed output, and producing the electronic output.

### CROSS REFERENCE TO RELATED APPLICATIONS

This application claims the benefit of the following provisional patent applications, each of which is incorporated by reference in its entirety: U.S. Provisional Application No. 60/506,206, filed Sep. 25, 2003; U.S. Provisional Application No. 60/506,263, filed Sep. 25, 2003; U.S. Provisional Application No. 60/506,302, filed Sep. 25, 2003; U.S. Provisional Application No. 60/506,303, filed Sep. 25, 2003; and U.S. Provisional Application No. 60/506,411, filed Sep. 25, 2003.

This application is also related to the following applications, each of which was filed on Mar. 30, 2004, and is incorporated by reference herein in its entirety: application Ser. No. ______, entitled, “Networked Printing System Having Embedded Functionality for Printing Time-Based Media,” Attorney Docket 20412-8341; application Ser. No. ______, entitled, “Printer With Hardware and Software Interfaces for Media Devices,” Attorney Docket 20412-8383; application Ser. No. ______, entitled, “Stand Alone Printer With Hardware/Software Interfaces for Sharing Multimedia Processing,” Attorney Docket 20412-8385; application Ser. No. ______, entitled, “Printer with Multimedia Server,” Attorney Docket 20412-8351; application Ser. No. ______, entitled, “Printer with Audio/Video Localization,” Attorney Docket 20412-8356; application Ser. No. ______, entitled, “Printer With Audio or Video Receiver, Recorder, and Real-Time Content-Based Processing Logic,” Attorney Docket 20412-8369; application Ser. No. ______, entitled, “Printer With Hardware and Software Interfaces for Peripheral Devices,” Attorney Docket 20412-8382; application Ser. No. ______, entitled, “Printing System With Embedded Audio/Video Content Recognition and Processing,” Attorney Docket 20412-8394; application Ser. No. ______, entitled, “Printer With Embedded Retrieval and Publishing Interface,” Attorney Docket 20412-8421; application Ser. No. ______, entitled, “Printer with Radio or Television Program Extraction and Formatting,” Attorney Docket 20412-8440; and application Ser. No. ______, entitled, “Multimedia Print Driver Dialog Interfaces,” Attorney Docket 20412-8454.

### BACKGROUND OF THE INVENTION

1. Field of the Invention

The present invention relates generally to networked printing systems and, more specifically, to document printers that can receive, process, and transform multimedia data from a peripheral device.

2. Description of the Related Art

A conventional printer can receive documents or other data in a number of formats and then print the contents of those documents or data in accordance with the proper format. But while conventional printers can print documents in a wide variety of formats, these printers are fundamentally limited in their ability to take in contents from multimedia devices such as video cameras and cellular phones and process the data to create a useable record. For example, it is standard technology for a printer to produce images of static text, pictures, or a combination of the two.

Meanwhile, cost and quality improvements in multimedia technologies have led to a proliferation of digital devices with multimedia capabilities. High-quality video cameras and cellular phones with multimedia capabilities are commonplace in the home and workplace, and are useful for diverse purposes ranging from teleconferencing to managing information. Multimedia data captured by such devices are typically delivered in an unprocessed form to a storage medium such as a digital tape or memory card.

Thus, there is a need for an integrated printer that can receive multimedia data from a peripheral device, process it, and deliver an output to a printed document or other media. It is further desirable that such a printer be able to perform at least some of the necessary processing itself, while some of the processing may be performed on an external device, rather than requiring an attached computer or other device to perform all of the processing.

### SUMMARY OF THE INVENTION

The present invention overcomes the deficiencies and limitations of the prior art by providing networked systems and methods in which multimedia data from peripheral devices are received by a printer, the data are processed, and the printer outputs the result.

In a typical hardware configuration for such a multifunction printer, a printer includes a peripheral interface that communicates with a peripheral device, a print engine that produces a paper or other printed output, and one or more electronic devices that produce a related electronic output. Together, the printed and electronic outputs provide an improved representation of the multimedia data from the peripheral device compared to a convention paper printer.

In one embodiment, a networked printing system has a network interface coupled to a network device via the network. The printing system also includes a peripheral interface coupled to a peripheral device. The interfaces receive multimedia data from a peripheral device (either directly coupled or via the network), and a multimedia processing system is coupled to the interfaces for processing the multimedia data. Based on any of a number of desired applications, the multimedia processing system determines a printed representation of the multimedia data and an electronic representation of the multimedia data. To share the computing load, the multimedia processing system resides at least in part on the printing system and at least in part on the network device. A printed output system in communication with the multimedia processing system receives the printed representation and produces a corresponding printed output. Similarly, an electronic output system in communication with the media processing system receives the electronic representation and produces a corresponding electronic output. In this way, the printer creates a representation of multimedia data from a peripheral device by producing a printed output and an electronic output.

In various embodiments, the system includes hardware and software for processing multimedia contents and various mechanisms for creating the electronic and printed outputs. For example, the interfaces may include a single communication interface, a network interface, a wireless interface, personal digital assistant (PDA) device, a cellular phone, a removable media storage device reader, a video input device (such as a DVD reader or a video cassette reader), an audio input device (such as a CD reader or an MP3 player), a digital video recorder (e.g., TiVO), screen capture hardware, a video and/or audio recorder, or any of a number of different types of devices that can receive multimedia data. Similarly, the electronic output system may write the electronic representation to one or more different types of removable media storage devices, such as a DVD, a digital video recorder, a digital audio recorder, video cassette tape, a CD, an audio cassette tape, a flash card, a computer disk, an SD disk, or another computer-readable medium. The electronic output system may also include a disposable media writer, a self-destructing media writer, a video display, an audio speaker, a driver for a speaker system (such as an embedded MIDI player), or an embedded web page display. In this way, a multifunction printer can be configured to process any of a large number of multimedia data from various peripheral devices, allowing various embodiments of the printer to meet the needs of many different applications.

Because of the great many combinations of input and output devices possible for the networked printing system, the system may include embedded or peripheral hardware, software, or a combination thereof for performing a wide variety of different operations on the multimedia data. In this way, the system can be configured to produce various types of printed and electronic outputs based on received multimedia data to meet the needs of different applications. To solve various problems, in embodiments of the system, the multimedia processing system includes one or more of an embedded multimedia module.

Moreover, the processing logic in the printing system can be configured to communicate with a peripheral device via the peripheral interface and/or the network interface. Thus, the processing logic has the capability to operate the peripheral device and transfer data to the peripheral device.

These different tasks may be performed on the printer by the multimedia processing system, or partially on the printer by the multimedia processing system in conjunction with one or more electronic devices capable of performing some of the required processing steps. The printer can thus balance the required processing of the multimedia data between the printer and one or more connected electronic devices, such as a personal computer or an external network service. By conducting at least some of the processing on the printer, the printer relieves at least some of the processing load from external devices that the printer's additional functionality may require.

### BRIEF DESCRIPTION OF THE DRAWINGS

FIG. 1 is a schematic diagram of a system in accordance with an embodiment of the invention.

FIG. 2 is a flow diagram of the operation of a system in accordance with an embodiment of the invention.

FIG. 3 is a schematic diagram of various peripheral interfaces of a printing system, in accordance with embodiments of the invention.

FIG. 4 is a schematic diagram of the printer's printed output system, in accordance with an embodiment of the invention.

FIG. 5 is a schematic diagram of various electronic media output systems of the printer, in accordance with embodiments of the invention.

FIG. 6 is a schematic diagram of a multimedia module of a printer, in accordance with an embodiment of the invention.

FIG. 7 is a flow diagram of the operation of a system for automatically receiving multimedia data from a docked peripheral device, in accordance with an embodiment of the invention.

FIG. 8 is an illustration of interactive communication with a printer in accordance with an embodiment of the invention.

### DETAILED DESCRIPTION OF THE PREFERRED EMBODIMENTS

Various embodiments of a networked printing system enable the printing of multimedia data in a useful and intelligent format. To create a representation of this multimedia data, the printing system produces a printed output and a related electronic output, which together provide a representation of the received multimedia data. Depending on the desired application, the printing system includes a multimedia module with functionality for processing the multimedia data, printing the printed output, and producing the electronic output. Therefore, a number of embodiments of the printing system are described herein to show how such a system can be configured in a wide variety of combinations.

System Architecture

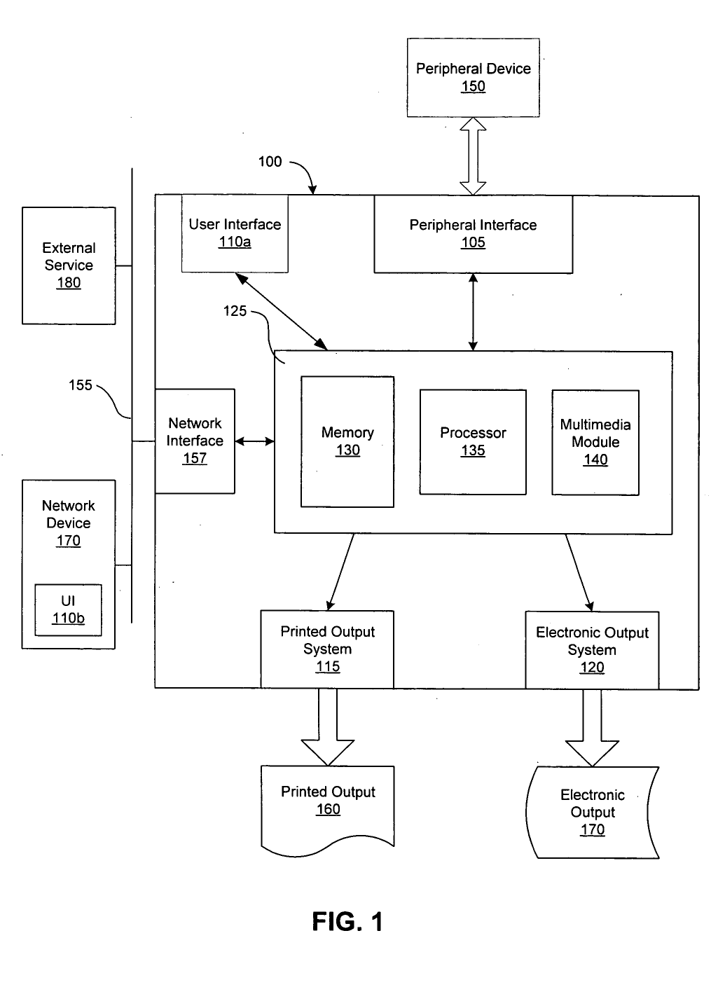

FIG. 1 is a diagram of one embodiment of a networked printing system, which includes a printer 100 in communication with a peripheral device 150 and a network device 170. A network 155 enables communication between the printing system 100 and the network device 170. Printing system 100 includes a peripheral interface 105, user interface 110a, a printed output system 115, an electronic output system 120, and a multimedia processing system 125. Capable of receiving multimedia data from a peripheral device 150 and a network device 170, the peripheral interface 105 and network interface 157, respectively, can each take a variety of forms and may include one or more devices that can receive multimedia data or create multimedia data by observing a media event. Similarly, the printed output system 115 and the electronic output system 120 can take a variety of forms and may each include one or more devices that can produce, respectively, a printed output 160 and an electronic output 170.

In one embodiment, the multimedia processing system 125 includes a memory 130, a processor 135, and a multimedia processing module 140. The multimedia processing module 140, which is described in more detail below, may include software, hardware, or a combination thereof for implementing at least a portion of the functionality of the printing system 100. The multimedia processing system 125 is coupled to the peripheral interface 105 and network interface 157, allowing it to communicate with each. The media processing system 125 is also coupled to the printed output system 115 and to the electronic output system 120 for providing the appropriate commands and data to those systems.

The printing system 100 further includes a network interface 157, functionally coupled to the multimedia processing system 125. The network interface 157 allows the printing system 100 to communicate with other electronic devices, such as network device 170 and external service 180. In one embodiment, the network device 170 is a computer system, such as a personal computer. Network device 170 includes processing capability for performing processing on the multimedia data. In this way, the network device 170 can relieve the printing system 100 of some of the processing load required to produce printed and electronic outputs from the multimedia data. In one embodiment, the network device 170 includes a user interface 110b that allows a user to make selections about the processing of the multimedia and/or about the format or destination of the printed or electronic outputs. In other embodiments, the user interface 110b can be located on another attached device, or the user interface 110a can be located on printer 100 itself. The user interface 110 may include a display system, software for communicating with an attached display, or any number of embodiments described in co-pending U.S. patent application Ser. No. ______ entitled, “User Interface for Networked Printer,” filed Mar. 30, 2004, Attorney Docket No. 20412-08456, which application is incorporated by reference in its entirety.

In another embodiment, the printing system 100 is coupled to an external service 180, which includes hardware and/or software for performing some of the processing tasks on the multimedia to be printed. In a typical embodiment, a remote service provider operates the external service 180. In such an embodiment, whereas the network device 170 may communicate with the printing system 100 over a local area network, the external service may communicate with the printing system 100 over a wide area network or over the Internet. By sharing the media processing tasks with an external service 180, possibly operated by a service provider, the printing system can perform tasks that are under the control of the service provider. In this way, a service can be set up around a particular form of multimedia processing, where a user pays for use of the service.

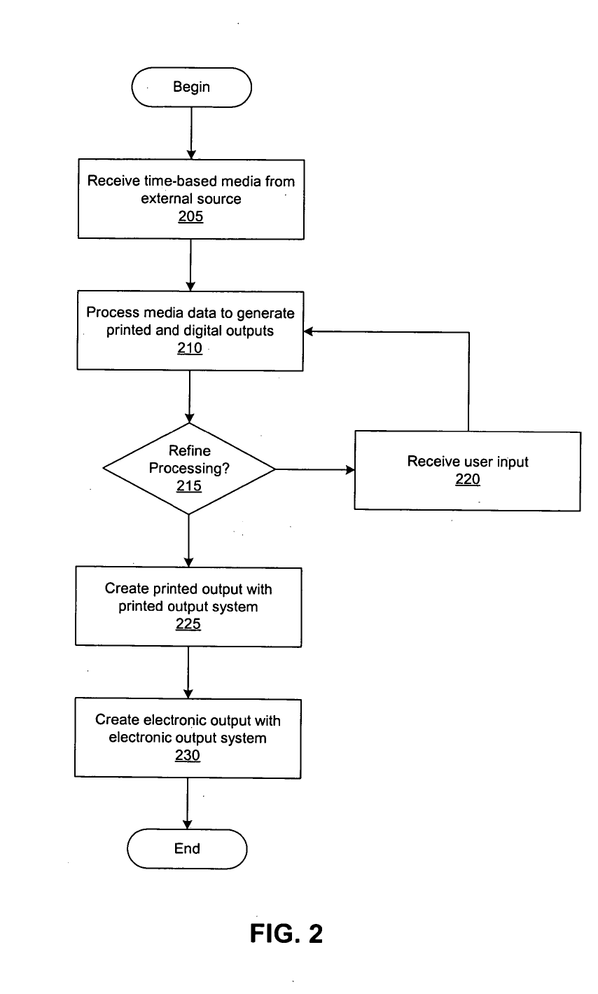

FIG. 2 shows an overview of a generalized process in which the printing system 100 creates a representation of multimedia data, in accordance with one embodiment of the invention. The system 100 first receives 205 multimedia data from a peripheral device 150 via the peripheral interface 105, or alternatively from a network device 170 via the network interface 157. This multimedia data may be received as digital or analog data, or it may be an observable event that the interface records as digital or analog data. Coupled to the interfaces 105, 157 to receive the multimedia data, the multimedia processing system 125 processes 210 the data to generate printed and electronic outputs. This processing 210 is performed in accordance with the intended functionality of the printing system 100, and examples of different operations are described in greater detail below.

In one embodiment, the system automatically generates a printed output or an electronic output of the multimedia data based on a predefined format and the functionality of the peripheral device 150 that is connected to the peripheral interface 105 or network interface 157. For example, the multimedia processing system can take a video clip from a digital video camera connected to peripheral interface 105 and automatically generate a printed output 160 containing keyframes and bar codes for accessing video segments of the video file.

In another embodiment, the system 100 includes a user interface 110 to allow a user to preview the generated outputs. If 215 the user desires to refine the processing, the user can enter commands, which the printing system 100 receives 220 by way of the user interface 110. Based on the user's commands, the printing system 100 then repeats the processing 210 of the media data to generate new printed and electronic outputs. This refinement process can be iterated until the user is satisfied with the printed and electronic outputs. When this occurs, the user indicates that the printing should commence, for example, by invoking a print command with the user interface 110. The multimedia processing system 125 then sends the generated printed output to the printed output system 115 and the electronic output to the electronic output system 120. The printed output system 115 then creates 225 a printed output 160, and the electronic output system 120 creates 230 an electronic output 170.

It can be appreciated that this generalized description of a multifunction printer lends itself to a great number of specific configurations and applications. Accordingly, examples of the possible configurations, applications, and particular components are further described.

Peripheral Interface

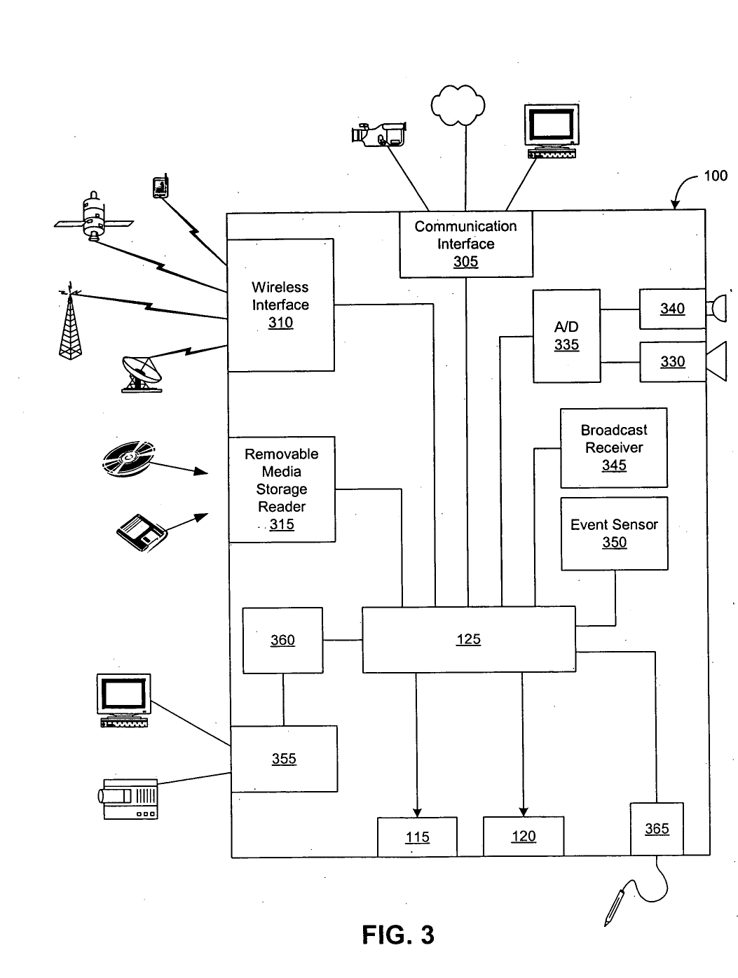

The peripheral interface 105 can be designed to accommodate any suitable type of multimedia peripheral device 150. Because of the great variety of types and formats of multimedia data, the peripheral interface 105 may take any number of forms to accept any devices 150 that a user might wish to connect to print the multimedia data. FIG. 3 illustrates some examples of different interfaces 105 by which the printer 100 can receive multimedia data from a peripheral device or network device. In particular implementations, system 100 may have only one or only a subset of these types of interfaces 105, and in addition may have other types of interfaces not shown.

As shown in FIG. 3, the printer 100 may include a communication interface 305 that allows the printer 100 to be communicatively coupled to another electronic device. Depending on the desired input, the interface 305 may allow the computer to communicate with a wide variety of different peripheral devices 150 that can provide the printer 100 multimedia data to print. Without intending to limit the types of devices, the interface 305 may allow the printer 100 to received media data from peripheral devices 150 such as computer systems, computer networks, digital cameras, cellular telephones, PDA devices, video cameras, media renderers (such as DVD and CD players), media receivers (such as televisions, satellite receivers, set-top boxes, radios, and the like), digital video recorders (such as a TiVO), a portable meeting recorder, external storage devices, video game systems, or any combination thereof. The connection type for the interface 305 can take a variety of forms based on the type of device that is intended to be connected to the printer 100 and the available standard connections for that type of device. For example, the interface 305 may comprise a port for connecting the device using a connection type such as USB, serial, FireWire, SCSI, IDE, RJ11, parallel port (e.g., bi-directional, Enhanced Parallel Port (EPP), Extended Capability Port (ECP), IEEE 1284 Standard parallel port), optical, composite video, component video, or S-video, or any other suitable connection type.

In another embodiment, the printing system 100 includes a wireless interface 310. As illustrated, the wireless interface 310 allows system 100 to receive multimedia data from a wireless device external to system 100. The wireless interface 310 may allow the system 100 to communicate with any number of wireless communication systems, such as wireless components on a home or business network, cellular phones and other portable wireless devices, satellites, satellite dishes, and devices using radio transmissions. Depending on the types of external devices with which system 100 is communicating, the wireless interface 310 may comprise hardware and/or software that implements a wireless communications protocol, such as that described in IEEE 802.11, IEEE 802.15, IEEE 802.16, or the Bluetooth standard.

In another embodiment, system 100 receives media data from a removable media storage reader 315 that is built into the printer 100. The removable media storage reader 315 may be configured to accommodate any type of removable media storage device, such as DVDs, CDs, video cassette tapes, audio cassette tapes, floppy disks, ZIP disks, flash cards, micro-drives, memory sticks, SD disks, or any other suitable type of multimedia storage device. Moreover, the printing system 100 may have a plurality of removable multimedia storage readers 315 to accommodate multiple types of media storage devices.

In another embodiment, system 100 includes a docking station 335 that is built into the printer 100. The docking station 335 may be configured to accommodate any type of peripheral device, such as cell phones, digital audio recorders, video camcorders, portable meeting recorders, fixed position meeting recorders, head-mounted video cameras, office-based PC experience capture systems, or any other suitable type of multimedia peripheral devices. Moreover, the printer 100 may have a plurality of docking stations 335 to accommodate multiple types of peripheral devices. Furthermore, it will be understood that a peripheral device 150 may also be communicatively coupled to the communication interface 305 via an external docking station.

In another embodiment, the printer may include video capture hardware 355. In one embodiment, the video capture hardware 355 is designed to be coupled to a computing system by a video cable thereof. The video cable from a display is attached to the printer 100, where the video signal is split with one signal directed to the computing system and another signal to the video capture hardware 355. The video capture hardware 355 performs a differencing between successive frames of the video signal and saves frames with a difference that exceeds a threshold on a secondary storage in the printer 100. This offloads such processing from the computing system, thereby improving responsiveness and user experience and providing an easily browseable record of a user's activities during the day. To take advantage of the printing capabilities of the multifunction printer, the user can choose to print selected frames captured by the video capture hardware 355. The printing can be generated on demand with the user interface 110 on the printer or from the attached computing system, or automatically with scheduling software. In this way, a user can view a replay of any actions taken on the computing system. Notably, the captured content can be effectively compressed because the differences between frames are small.

In another embodiment, the video capture hardware 355 is coupled to a converter module 360, such as VGA-to-NTSC conversion hardware. Such an embodiment could be used in conjunction with a projector to capture presentations made with the projector. Audio capture could also be employed to record a speaker's oral presentation. To use the video capture hardware 355 in this way, a user could connect a laptop or other computing system and the projector to the printer 100. The printer 100 then captures video frames and compares them to the most recently captured frame and retains those frames that are different. A parallel audio track may also be saved. This capability could also be used in a desktop printer to record a presentation made on a computing system connected to the printer. The printer can then serve the audio itself or it can be written to a digital medium, such as an SD disk that can be played from a cell phone or a PDA. The audio could also be written to a bar code on a printed representation.

Printed Output System

The printed output system 115 may comprise any standard printing hardware, including that found in standard laser printers, inkjet printers, thermal wax transfer printers, dye sublimation printers, dot matrix printers, plotters, or any other type of printing mechanisms suitable for creating a printer image on an appropriate physical medium. In the example described herein, a laser printer mechanism is described; however, it should be understood that any suitable printing system can be used. The printing system 100 includes any necessary subsystems, as know by one skilled in the art, to print on a printable medium, such as a sheet of paper.

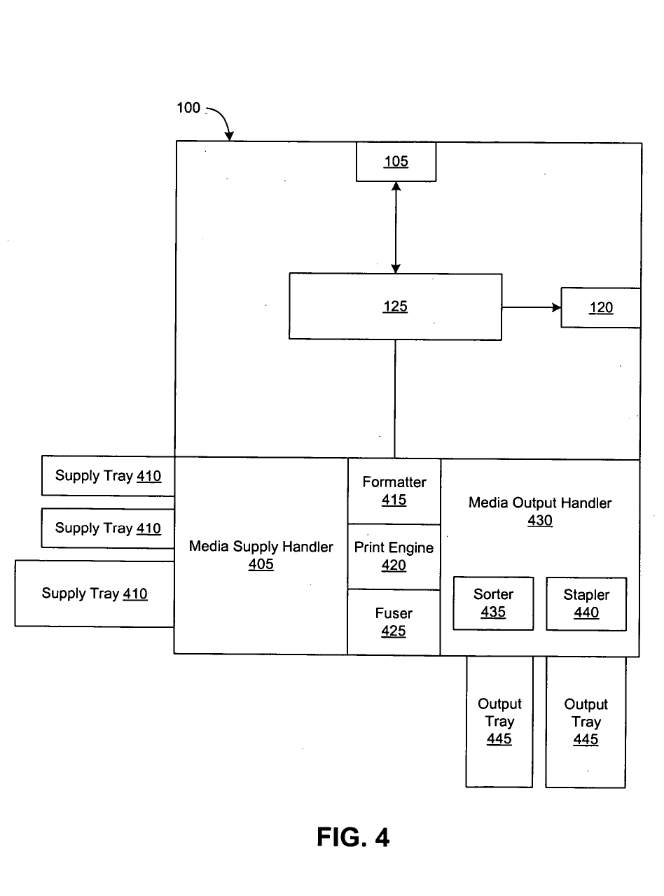

In one embodiment, the printed output system 115 comprises a media supply handler 405 (FIG. 4) that receives blank paper to be printed on. The media supply handler 405 typically obtains the paper from a supply tray 410. The printer 100 may include multiple supply trays 410, allowing the printer to accommodate different sizes and types of paper as well as trays 410 of varying capacity. When the printer 100 needs blank paper for printing, the media supply handler 405 provides the print engine 420 with a sheet of blank medium.

The formatter 415 converts data received from the multimedia processing system 125 into a format that the print engine 420 can use to create an image on the paper. The print engine 420 creates an image on the paper as indicated by the formatter 415. A fuser 425 then uses high temperature and pressure to fuse the image onto the paper to fix the image thereon. Once the image is fixed, the paper is fed to the media output handler 430. Although not shown, it is appreciated that the printer 100 includes any necessary motors, gears, and diverters to cause the paper to move through the printer 100.

The media output handler 430 receives one or more printed sheets of paper and performs any requested finishing to the sheets. For example, the media output handler 430 may include a sorter 435 to sort or collate the sheets for multiple copies and a stapler 440 to attach the sheets together. When the finishing process is complete, the media output handler 430 moves the sheets to an output tray 445, of which there may be multiple trays 445 to accommodate different sizes, types, and capacities of printed output.

Electronic Output System

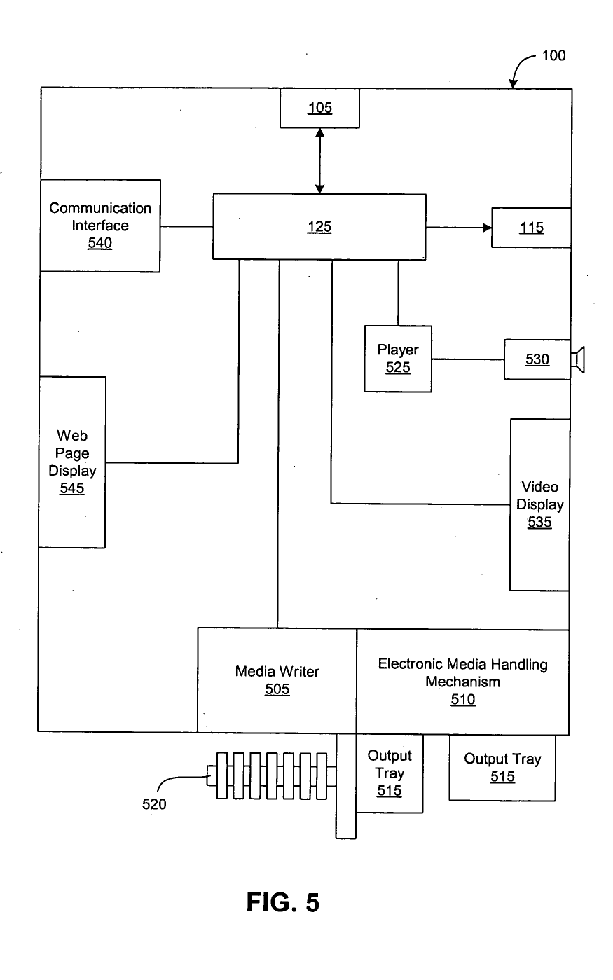

The electronic output system 120 can be designed to produce an electronic output related to the multimedia data in any desired format. Because of the great variety of types and formats of electronic outputs, the electronic output system 120 may take any of a number of forms for producing an electronic output desired by the user. FIG. 5 illustrates some examples of different embodiments of the electronic output system 120. In particular implementations, system 100 may have only one or only a subset of the various components shown, and in addition it may have other types of not shown.

In one embodiment, the printer 100 writes the electronic output to a removable media device with a media writer 505. Many different types of media writers are known in the art, and the media writer 505 many comprise any of these. For example, the media writer 505 may be configured to write the electronic output to removable storage devices such as a writeable DVD or CD, a video cassette tape, an audio cassette tape, a flash card, a computer disk, an SD disk, a memory stick, or any other appropriate electronically-readable medium. Moreover, the electronic output system 120 may include a number of media writers 505 of different types to allow the printer 100 to print onto different electronic formats. In addition, the electronic output system 120 may include a number of media writers 505 of the same type to increase the output capacity of the printer 100.

The removable storage device that receives the electronic output from the printer 100 may be fed to the media writer directly by a user, for example by inserting a blank disk into a drive. In another embodiment, the printer 100 includes an electronic media handling mechanism 510 coupled to the media writer 505 that automatically provides the media writer 505 with an appropriate type of removable storage device. The handling mechanism 510 may further be configured to physically place written-to storage devices into an output tray 515. In one embodiment, a series of blank storage devices are fed to the printing system 100 by a bandolier 520 or other type of feeder, allowing the printer 100 to create a high volume of electronic output without requiring a significant amount of interaction with a human operator. The bandolier 520 preferably then places the written-to devices into an output tray 515.

In another embodiment, the media writer 505 is a disposable media writer, configured to write electronic data to a disposable removable media storage mechanism. In another embodiment, the media writer 505 writes the electronic data to a self-destructing medium. In this way, a user can view the electronic data for a predetermined number of times or during a predetermined period of time, after which the electronic data are no longer viewable.

In another embodiment, the electronic output system 120 includes a speaker system 530. The speaker system 530 is designed to receive an audio signal from the media processing system 125, in response to which the audio is played from an embedded speaker 530 in the printer 100. The electronic output system 120 may further include a player 525 or audio renderer that receives an encoded audio signal from the media processing system 125 and converts it into an audio signal for the speaker 530. The player 525 thus takes some of the processing load off the media processing system 125. For example, the player 525 may include a MDI player for generating the audio signal; however, many other audio renderers may be used, in either hardware or software.

In another embodiment, the electronic output system 120 includes a video display 535. The video display 535 is designed to receive a video signal from the media processing system 125, in response to which the video is played on the video display 535 embedded in the printer 100. Similarly, the video display 535 may receive the video signal directly from a driver to reduce the processing load on the, media processing system 125.

In another embodiment, the printer 100 transmits the electronic output that is to be printed to another device as a signal. This signal can later be fixed in a tangible medium by the external device. To facilitate this, the electronic output system 120 includes a communication interface 540. The communication interface receives the electronic output from the media processing system 125 and sends the electronic output to the external device, which may be in communication with the printer 100 over a local network, the Internet, a wireless network, a direct connection, or any other suitable communication means.

In another embodiment, the electronic output system 120 comprises an embedded web page display 545. The web page display 545 allows a user to see a representation of the electronic output in a web-based form.

Multimedia Processing System

The multi media processing system 125 of the printer 100 is designed to perform the specialized functionality of the multifunction printer 100. To send and receive messages between external devices or the user interface 110, the processing system 125 includes a processor 135 and a memory 130. In addition, the media processing system includes one or more hardware and/or software modules that enable the printer 100 to create related printed and electronic outputs for different types of multimedia data. In this way, the printer 100 can be configured to have a wide variety of multimedia processing functionalities.

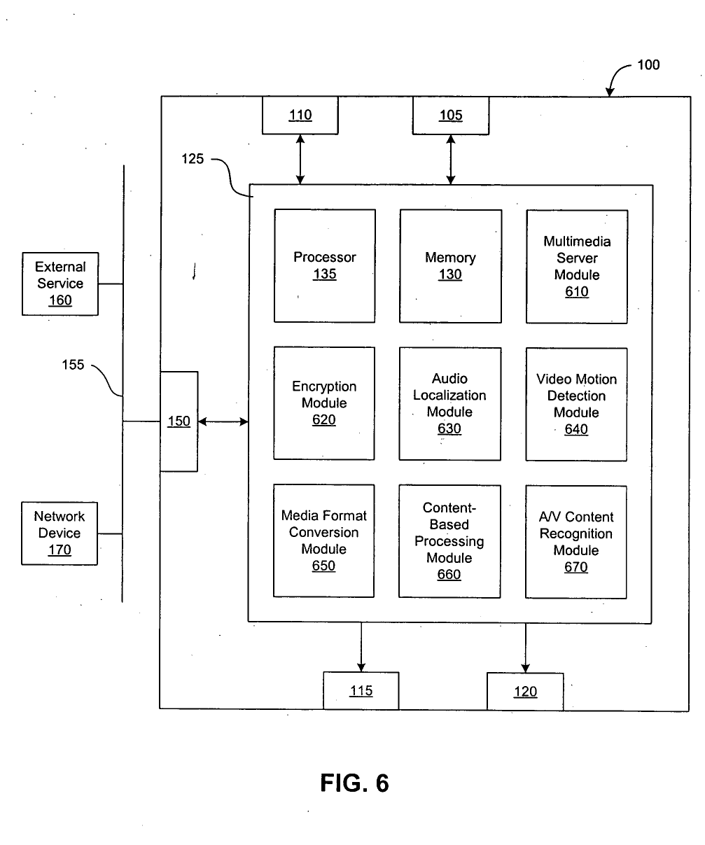

In one embodiment, as illustrated in FIG. 6, multimedia module 140 includes software and hardware to automatically detect 602 the coupling of a peripheral device 150, a module to communicate with a peripheral device 604, a module to process and format multimedia data 606, and a module to generate an output 608. Multimedia module 140 is also configured to detect the presence of and communicate with a network device 170 in a similar manner.

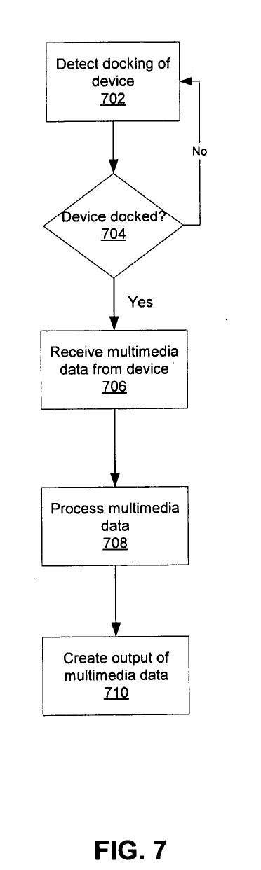

In an embodiment, as illustrated in FIG. 7, the device detection module 602 automatically detects 702 the docking (or communicative coupling via a network) of a peripheral device 150 and downloads multimedia data from the peripheral device for processing by the printer 100. The multimedia processor 125 can utilize such protocols as the Plug and Play (PnP) or Universal Plug and Play (UPNP) protocol to automatically detect and communicate with devices that have PnP capabilities. With UPnP, a device can automatically communicate with other devices directly, convey its capabilities, and learn about the presence and capabilities of other devices. Those skilled in the art will recognize that other detection methods, such as polling techniques, may be used to automatically detect the coupling of a peripheral device. Alternative systems for connection, such as IEEE 1394 cabling or Universal Serial Bus cabling, have equivalent standards for device and capability discovery. Alternatively, one embodiment detects the presence of an active electrical circuit in a physical connector, such as an RS232 serial port connector, between the docked device and printer 100.

Once a device is docked to the printer 100 via peripheral interface 105 or network interface 157, the device communication module 604 is configured to communicate with the peripheral device 150. Again, PnP capabilities of a device will allow the communication module 604 to communicate with the device. The communication module 604 may be configured with specific software drivers to enable communication with specific peripheral devices. In one embodiment, the communication module 604 enables the printer 100 to operate a docked peripheral device to capture multimedia data. In such an embodiment, the printer 100 can also send commands to the docked peripheral device 150 and operate the device by controlling certain functionalities of the device. For example, the printer 100 could communicate with a docked cell phone to automatically bill the owner of the phone through her cell phone provider, or based on information in an XML profile on the phone. In another example, the printer 100 can communicate with a docked cell phone to issue commands to take pictures with the cell phone's digital camera or to call a number from the cell phone. The picture might show who is standing at the printer 100. That data could be transmitted to some other destination by the cell phone when it calls out. The called number could be provided in a profile stored on the cell phone, or it could be stored on the printer. Other examples are discussed below.

The communication module 604 sends 706 a request to the peripheral device for multimedia data to be downloaded to the printing system 100. Once the multimedia processing system 125 receives the multimedia data, the multimedia processing and formatting module 606 contains logic to format and process the multimedia data. In an embodiment, the format may be pre-defined and configured for specific peripheral devices. In other embodiments, a user may design a layout format for the multimedia data via the user interface 110. In yet another embodiment, a user may upload a predefined format. The multimedia processing and formatting module 606 provides an organized representation of the multimedia data depending on a particular peripheral device 150. For example, the formatter 606 may generate a format suitable for representation on printed output 160. Thus, if a video camcorder is docked directly to the printer, the format might comprise key frames with bar codes linking the key frames to different segments of a video file that may be used to replay a recorded video describing the event. Although the media processing system 125 is configured to perform at least some of the processing of the media data on the printer 100, it is preferably coupled to an external computing device that shares some of the computing burden. Network interface 157 allows communication with external network device 170 and/or external service 180, which are capable of performing at least a portion of the multimedia processing functionality. The network device 170 may be a computer system or a dedicated media processing hardware device. In this way, the printer 100 relieves the source of the multimedia from at least some of the processing burden required to implement the printer's functionality, but the printer 100 need not shoulder the entire burden. The printer 100 can thus avoid slow-downs that can result from a heavy processing load, which may be especially important for shared printers. In an alternative embodiment, a peripheral device might initiate the download process, by requesting a connection with communication module 604. In this embodiment, the peripheral device might have a dedicated hardware button or a software interface which allows a user to initiate a transfer process by performing some action.

Printer With Multimedia Functionality

Printer 100 may include an embedded multimedia server module 610 that enables the printer 100 to act as a multimedia server and have associated functionality. In various embodiments, the multimedia server module 610 (610 is not shown in FIG. 6) includes hardware and software for carrying out multimedia functionality, media processing software, and computer interface hardware and software. In this way, the printer 100 can act like a multimedia server, which could be shared by a work group or used as a personal printer. Various embodiments of a multifunction printer having multimedia functionality are possible applications for a printer in accordance with embodiments of this invention. A number of specific embodiments for such a printer are described in a co-pending U.S. patent application Ser. No. ______ entitled “Printer with Multimedia Server,” to Hull et. al, filed Mar. 30, 2004, Attorney Docket 20412-8351, incorporated herein by reference in its entirety.

In step 710, the multimedia output generator module 608 creates an output of the formatted multimedia data. The output may be sent to the printed output system 115 where it will be printed on a document, or it may be sent to the electronic output system 120 where an electronic output will be produced. In one embodiment, the output may also be uploaded to a web server via network 155.

Interactive Communication with a Printer

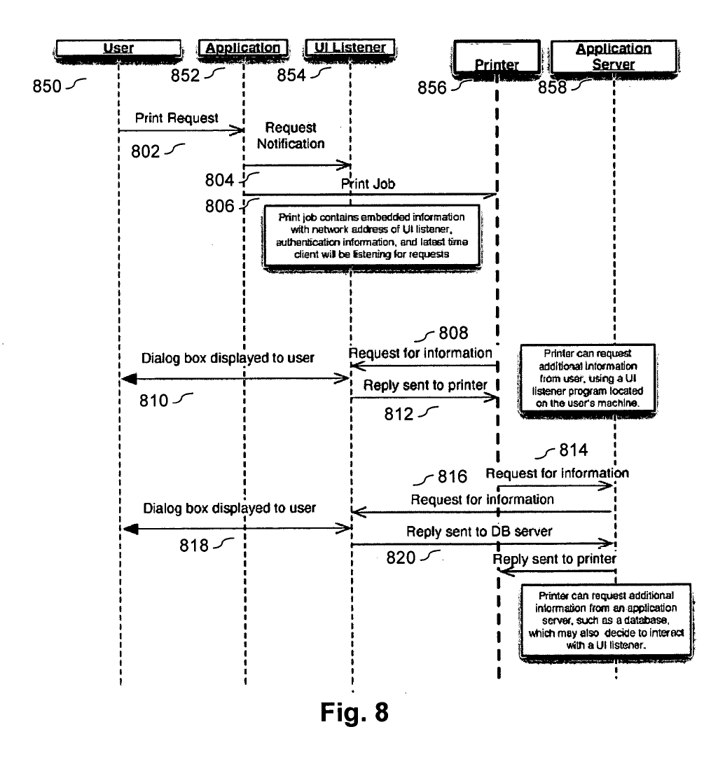

FIG. 8 shows an example of interactive communication with a printer in accordance with an embodiment of the present invention. In general, conventional printer drivers in modern operating systems are not designed to facilitate interactive information gathering. Because a print job can be redirected to another printer, or the printing protocol does not allow such interactive sessions, the operating system does not encourage interaction with the user. Once initial printer settings are captured, further interactions are generally not allowed in conventional printers. One approach to this problem is to embed metadata into the print stream itself, as noted above. However, it is possible that the printer could need to ask the user for more information, in response to computations made from the data supplied by the user. In addition, the printer might itself delegate some tasks to other applications on other devices, which might in turn need more information from the user. So-called “Web services” or “grid computing” systems are examples of the sort of application server that the printer might trigger.

In order to allow this interaction, without modifying printer driver architecture of the underlying operating system, an extra mechanism, such as the one shown in FIG. 8, is constructed. A “UI Listener,” program 854 listens to a network socket, accepts requests for information 808, interacts with a user to obtain such data, and then sends the data back to the requester.

Once a print request 802 is sent by user 850 and notification requested from the UI listener 804, the print job is sent by application 852. Here, the print job contains embedded information including the network address of the UI listener, authentication information, and the latest time that the client will be listening for requests.

If the printer requires additional information of confirmation, it sends a request 808, which is detected by the UI listener, which displays a dialog box to obtain input from the user 810. An example of such a request might be a request for a password or user confirmation code that the user must enter to access a database 858. The user's input is included in a reply 812 sent to the printer. If the reply does not satisfy the printer it may ask for additional information (not shown). If the reply does satisfy the printer, it takes a next step. This step might be to perform an external action such as sending an email (not shown). The next step might also be sending a request for information 814 to an application server (such as a database) 858. In this example, application server 858 also sends a request for information 816, which is detected by the UI listener 854. The user is prompted 818 and his response forwarded to the application server 820. In this example, a reply is then sent from the application server 858 to the printer 856. It will be understood that a particular embodiment may include either or none or requests 808 and 816 without departing from the spirit of the present invention.

A program such as that shown in FIG. 8 may have a fixed set of possible interactions, or may accept a flexible command syntax that allows the requester to display many different requests. An example of such a command syntax is the web browser's ability to display HTML forms. These forms are generated by a remote server, and displayed by the browser, which then returns results to the server. In this embodiment, however, the UI listener is different from a browser in that a user does not generate the initial request to see a form. Instead, the remote machine generates this request. In the described embodiment, the UI listener is a server, not a client.

Because network transactions of this type are prone to many complex error conditions, a system of timeouts preferably assures robust operation. Normally, each message sent across a network either expects a reply or is a one-way message. Messages which expect replies preferably have a timeout, a limited period of time during which it is acceptable for the reply to arrive. In this embodiment, embedded metadata includes metadata about a UI listener that will accept requests for further information. Such metadata preferably includes at least a network address, port number, and a timeout period. It can also include authentication information, designed to prevent malicious attempts to elicit information from the user. Because the user cannot tell whether the request is coming from a printer, a delegated server, or a malicious agent, prudence suggests strong authentication by the UI listener. Information which specifies the correct authentication data is sent as a part of Request Notification 804, along with timeout information and the identity of the requesting printer, in one embodiment. If the printer or a delegated application server wishes more information, it can use the above noted information to request that the UI listener ask a user for the needed information.

In one embodiment, printer 100 includes an interface 150 configured to support an image capture device. Examples of an image capture device include a digital still camera and a digital video camera. The user prints a document that contains instructions that drive the image capture device attached to the printer. The camera may be attached directly to the printer, e.g., via a cable, or may be wirelessly connected, for example using an 802.11 wireless networking connection. This allows the device to be located more remotely from the printer. The device can be instructed to take pictures or capture video immediately, or at some time in the future. The device is further instructed to print the captured pictures, either through the printed output system 115, the electronic output system 120, or both.

In various embodiments, printing system 100 includes a variety of peripheral interfaces 105 and network interfaces 157. For example, in one embodiment, printing system 100 includes an interface for a wireless keyboard. In another embodiment, a interface is included for capturing audio. In a further embodiment, an RJ-11 pass-through is included in printing system 100, in order to monitor telephone activity and print summary information about the calls. Attention is again drawn to U.S. patent application Ser. No. ______ entitled, “Printer With Multimedia Server.”

Other embodiments provide interfaces with additional functionality. Some examples of additional functionality include a Bluetooth interface for recording and relaying data; a cellular telephone interface for downloading and printing images, audio and video clips from a cellular telephone; a hardware and software interface for a digital audio recorder or digital video recorder; a hardware and software interface for a portable or fixed-position meeting recorder, including those with pan, tilt and zooming capabilities; an interface for a head-mounted video camera with a gyroscope and GPS capture; an interface for capturing activity in an office environment; and an interface for capturing video from a frame buffer of a computer.

In further embodiments, printing system 100 includes embedded technology such as a video reformatter; multimedia document formatter; video event detection logic; video foreground/background segmentation logic, face image detection, face image matching, facial recognition, and face extraction, matching and cataloging logic; video text localization and video OCR logic; video foreign language translation; video clip and video frame classification, including trainable video clip classification; digital image stitching; audio re-formatting; speech recognition; audio event detection; waveform matching; foreign language translation; caption alignment including caption alignment using video OCR; closed caption extraction and reformatting; speech recognition and closed caption plus transcript output; TV news segmentation and formatting; music cataloging; video database logic; movie database logic; digital photo catalog logic; multimedia retrieval; audio and video clip segmentation and web publishing logic; world-wide web search logic; video clip retrieval and keyframe selection; image searching logic; weather map retrieval logic; aerial image retrieval logic, including image recognition and highlighting; streamlining media server logic; single and multi-channel streaming video monitoring and downloading; streaming audio monitoring, downloading and printing; meeting minutes extraction logic; video shot selection logic based on multiple audio sources; video clip segmentation logic including participant identification and cataloging; video clip segmentation based on audio event detection; embedded TV schedule traction and formatting logic; radio news segmentation and formatting logic; radio program segmentation logic including face image retrieval; radio program segmentation and automatic home page retrival; “books on tape” speech recognition and formatting software, including foreign language translation and formatting; map generation software for routing; route planning logic; forms recognition logic; text-to-speech logic; document summarization and text-to-speech logic; graph printing logic; and RFID signaling apparatus and variable content selection logic.

Further descriptions of the various embodiments described above are included in the following co-pending U.S. patent applications: “Printer With Hardware and Software Interfaces for Peripheral Devices,” filed Mar. 30, 2004, Attorney Docket No. 20412-08382; “Printing System With Embedded Audio/Video Content Recognition and Processing,” filed Mar. 30, 2004, Attorney Docket No. 20412-08394; “Printer With Embedded Retrieval and Publishing Interface,” filed Mar. 30, 2004, Attorney Docket No. 20412-08421; “Printer with Radio or Television Program Extraction and Formatting,” filed Mar. 30, 2004, Attorney Docket No. 20412-08440; and “Printer With Document-Triggered Processing,” filed Mar. 30, 2004, Attorney Docket No. 20412-08449. Each of these references is incorporated herein in its entirety.

While examples of suitable printing systems are described above, the description of the printer and its document production means is not meant to be limiting. Depending on the intended application, a printer can take many different forms other than the typical office or home-use printer with which most people are familiar. Therefore, it should be understood that the definition of a printer includes any device that is capable of producing an image, words, or any other markings on a surface. Although printing on paper is discussed above, it should be understood that a printer in accordance with various embodiments of the present invention could produce an image, words, or other markings onto a variety of tangible media, such as transparency sheets for overhead projectors, film, slides, canvass, glass, stickers, or any other medium that accepts such markings.

In addition, the description and use of multimedia and multimedia data are not meant to be limiting, as multimedia may include any information used to represent any kind of media or multimedia content, such as all or part of an audio and/or video file, a data stream having multimedia content, or a transmission of multimedia content. Multimedia content may include one or a combination of audio (including music, radio broadcasts, recordings, advertisements, etc.), video (including movies, video clips, television broadcasts, advertisements, etc.), software (including video games, multimedia programs, graphics software, etc.), and pictures; however, this listing is not exhaustive. Furthermore, multimedia data may further include anything that itself comprises multimedia content or multimedia data, in whole or in part, and multimedia data includes data that describes a real-world event. Multimedia data can be encoded using any encoding technology, such as MPEG in the case of video and MP3 in the case of audio. They may also be encrypted to protect their content using an encryption algorithm, such as DES, triple DES, or any other suitable encryption technique.

Moreover, any of the steps, operations, or processes described herein can be performed or implemented with one or more software modules or hardware modules, alone or in combination with other devices. It should further be understood that portions of the printer described in terms of hardware elements may be implemented with software, and that software elements may be implemented with hardware, such as hard-coded into a dedicated circuit. In one embodiment, a software module is implemented with a computer program product comprising a computer-readable medium containing computer program code, which can be executed by a computer processor for performing the steps, operations, or processes described herein.

In alternative embodiments, the printer can use multiple application servers, acting in cooperation. Any of the requests or messages sent or received by the printer can be sent across a network, using local cables such as IEEE1394, Universal Serial Bus, using wireless networks such as IEEE 802.11 or IEEE 802.15 networks, or in any combination of the above.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

1. A system for printing multimedia data, the system comprising:
a network including a printing system and a network device;
a network interface for receiving multimedia data from the network device;
a media processing system coupled to the network interface to receive the multimedia data, the media processing system determining a printed representation of the multimedia data and an electronic representation of the time-based multimedia data, wherein the media processing system resides at least in part on the printing system and at least in part on the network device;
a printed output system in communication with the multimedia processing system to receive the printed representation, the printed output system producing a corresponding printed output from the printed representation of the multimedia data; and
an electronic output system in communication with the multimedia processing system to receive the electronic representation, the electronic output system producing a corresponding electronic output from the electronic representation of the multimedia data.

2. The system of claim 1, wherein the network device is a personal computer.

3. The system of claim 1, wherein the network is a local area network.

4. The system of claim 1, further comprising:
a remote external service system coupled to the network, the external service system in communication with the media processing system for performing at least some processing steps for multimedia data.

5. The system of claim 3, wherein the external service system is coupled to the network by the Internet.

6. The system of claim 1, wherein the interface comprises a removable media storage reader.

7. The system of claim 1, wherein the interface comprises a media input device selected from a group consisting of: a DVD reader, a video cassette tape reader, a CD reader, an audio cassette tape reader, and a flash card reader.

8. The system of claim 1, wherein the external source is a media broadcaster, and wherein the interface comprises a media broadcast receiver that can be tuned to a media broadcast.

9. The system of claim 1, wherein the interface comprises an embedded receiver selected from a group consisting of: an embedded TV receiver, an embedded radio receiver, an embedded short-wave radio receiver, an embedded satellite radio receiver, an embedded two-way radio, and an embedded cellular phone.

10. The system of claim 1, wherein the network device is a device selected from a group consisting of: an embedded heat sensor, an embedded humidity sensor, an embedded National Weather Service radio alert receiver, and an embedded TV Emergency Broadcast System (EBS) alert monitor.

11. The system of claim 1, wherein the network device comprises screen capture hardware.

12. The system of claim 1, wherein the network device comprises an ultrasonic pen capture device.

13. The system of claim 1, wherein the network device comprises a video recorder, wherein the external source of media is a series of images captured by the video recorder, converted into an electrical format, and then provided to the media processing system.

14. The system of claim 1, wherein the network device comprises an audio recorder, wherein the external source of media is a series of sounds that are converted into an electrical format by the audio recorder and then provided to the media processing system.

15. The system of claim 1, wherein the electronic output system is configured to write the electronic representation to a removable media storage device.

16. The system of claim 15, wherein the removable storage device is selected from a group consisting of: a DVD, a video cassette tape, a CD, an audio cassette tape, a flash card, a computer disk, an SD disk, and a computer-readable medium.

17. The system of claim 1, wherein the electronic output system comprises a handling mechanism to accommodate a plurality of removable storage devices.

18. The system of claim 17, wherein the handling mechanism is selected from a group consisting of: a feeder, a bandolier, and a tray.

19. The system of claim 1, wherein the electronic output system comprises a media writer selected from a group consisting of: a disposable media writer and a self-destructing media writer.

20. The system of claim 1, wherein the electronic output system is coupled to a speaker system and sends an audio signal to the speaker system.

21. The system of claim 20, wherein the electronic output system comprises an embedded sound player for generating the audio signal.

22. The system of claim 1, wherein the electronic output system comprises a web page display.

23. The system of claim 1, wherein the media processing system comprises a multimedia server.

24. The system of claim 1, wherein the media processing system comprises an audio encryption module.

25. The system of claim 1, wherein the media processing system comprises a video encryption module.

26. The system of claim 1, wherein the media processing system comprises an audio sound localization module.

27. The system of claim 1, wherein the media processing system comprises a video motion detection module.

28. The system of claim 1, wherein the network device includes a user interface that provides information to a user about at least one of the printed representation and the electronic representation of the multimedia data, the user interface further accepting input from a user to cause the media processing system to modify at least one of the printed representation and the electronic representation of the multimedia data.

29. The system of claim 1, wherein the media processing system determines at least one of the printed representation and the electronic representation with assistance from a networked computing device.

30. A method for printing multimedia data, the method comprising:
receiving multimedia data from a network device via a network;
processing the multimedia data to determine a printed representation of the multimedia data and an electronic representation of the multimedia data, the processing performed at least in part within a printing system and in part within the network device;
producing a printed output that corresponds to the printed representation of the multimedia data; and
producing an electronic output that corresponds to the electronic representation of the multimedia data.

31. The method of claim 30, wherein the electronic output is stored on a media recorder.

32. The method of claim 30, wherein the electronic output is stored on a removable storage device.

33. The method of claim 32, wherein the removable storage device is a DVD.

34. The method of claim 32 wherein the removable storage device is a CD-ROM.

35. The method of claim 32 wherein the removable storage device is an audio cassette tape.

36. The method of claim 32 wherein the removable storage device is a video tape.

37. The method of claim 32 wherein the removable storage device is a flash card.

38. The method of claim 32 wherein the removable storage device is a memory stick.

39. The method of claim 32 wherein the removable storage device is a computer disk.

40. The method of claim 30, wherein the network device includes a cellular telephone.

41. The method of claim 30, wherein the network device includes a video camcorder.

42. The method of claim 30, wherein the network device comprises a digital audio recorder.

43. The method of claim 30, wherein the network device includes a DVD reader.

44. The method of claim 30, wherein the network device includes a video cassette tape reader.

45. The method of claim 30, wherein the network device includes a CD reader.

46. The method of claim 30, wherein the network device includes an audio cassette tape reader.

47. The method of claim 30, wherein the network device includes a flash card reader.

48. The method of claim 30, wherein the network device includes a digital video recorder.

49. The method of claim 30, wherein the network device includes a video capture device.

50. The method of claim 30, wherein the network device includes a meeting recorder.
